(19) United States
(12) Patent Application Publication
(10) Pub. No.: US 2013/0200730 A1
(43) Pub. Date: Aug. 8, 2013

(54) Energy upload device

(71) Applicants: Raymond William Nowicki, Garfield, NJ (US); Robert Joseph Hewitt, Walnutport, PA (US)

(72) Inventors: Raymond William Nowicki, Garfield, NJ (US); Robert Joseph Hewitt, Walnutport, PA (US)

(21) Appl. No.: 13/137,946

(22) Filed: Feb. 6, 2012

(51) Int. Cl. H02J 3/32

(52) U.S. Cl. 307/151

(57) ABSTRACT

The Energy Uploader is a device using several components to achieve it's end result. The Energy Uploader operates in conjunction with any motor vehicles 12-volt dc charging system and works independently of the vehicles primary electrical system to produce 120-volt ac electrical energy that can be used or sold to the public utility power grid when the car is shut off.

### BACKGROUND OF INVENTION

This invention produces usable alternating current (AC) energy from any motorized vehicle with an alternator and puts the AC to power grid. The Energy Uploader can be used with Automobiles, Trucks, Busses, Tractor or any motorized vehicle.

Although certain types of power invertors do exist, they currently do not have the ability safely transfer electrical energy from a motorized vehicle to the power grid.

### SUMMARY OF THE INVENTION

The Energy Uploader is used to capture and store the electrical power generated by a motor vehicle once the primary battery is charged. This stored electrical direct current (DC) electrical energy is converted to AC and uploaded to the power grid.

### BREIF DESCRIPTION OF THE DRAWINGS

FIG. 1 shows the process and related components to the Energy Uploader.

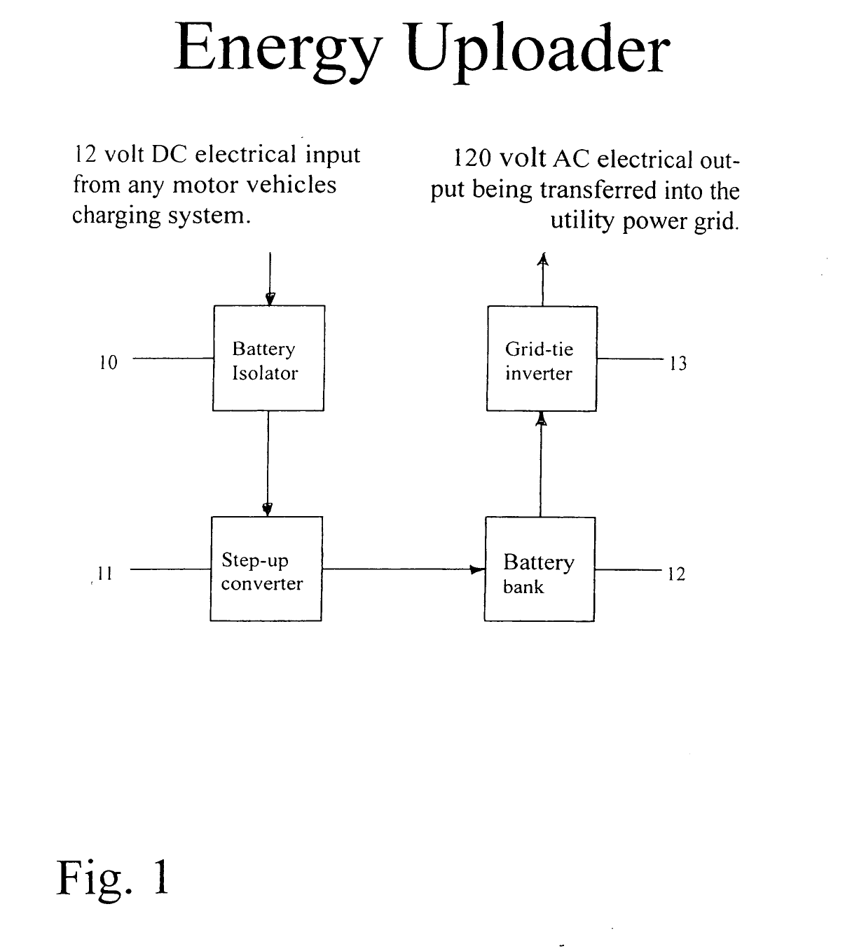

### DETAILED DESCRIPTION

Using the vehicles existing alternator, a battery isolator monitors the rate-of-charge and condition of the vehicles primary battery. Once the primary battery is fully charged the battery isolator redirects the 12-volt dc electrical energy to an electrical step-up converter that converts the 12-volt input to 24-volt output. At this point the 24-volt output is stored in a secondary battery bank. When the battery bank is fully charged the battery isolator signals the alternator that charging is complete. When the vehicle is parked and the vehicle is shut-off. A retractable 15 amp electrical cord that is mounted within the vehicle can be plugged into any standard 15 amps or greater electrical socket. Once this connection is made, the vehicles on-board grid-tie inverter is activated and begins the process of converting the stored 24-volt dc energy into 120-volt ac electrical energy that can be immediately used or uploaded into the utility power grid

I claim:

1. This process of using a motorized vehicle with battery isolator combined with a step up inverter, a battery bank and a grid tie inverter is unique and has not been put together in this process to produce electricity into the power grid.
